(19) United States
(12) Patent Application Publication
(10) Pub. No.: US 2025/0364854 A1
(43) Pub. Date: Nov. 27, 2025

(54) DRIVE DEVICE HAVING A BRUSHLESS ELECTRIC MOTOR

(71) Applicant: Brose Fahrzeugteile SE & Co. Kommanditgesellschaft, Bamberg, Bamberg (DE)

(72) Inventors: Michael SPETH, Gerbrunn (DE); Sascha KUNKEL, Wuerzburg (DE)

(73) Assignee: Brose Fahrzeugteile SE & Co. Kommanditgesellschaft, Bamberg, Bamberg (DE)

(21) Appl. No.: 19/294,949

(22) Filed: Aug. 8, 2025

Related U.S. Application Data
(63) Continuation of application No. PCT/EP2024/053203, filed on Feb. 8, 2024.

(30) Foreign Application Priority Data
Feb. 9, 2023 (DE) 10 2023 201 068.2

(51) Int. Cl. H02K 1/18; H02K 1/14; H02K 5/22

(52) U.S. Cl. CPC H02K 1/187; H02K 1/146; H02K 5/225

(57) ABSTRACT

A drive device, comprising a brushless electric motor with a stator, which has a rotary-field or stator winding and a hollow-cylindrical stator carrier, and comprising a drive housing and a connection element for fitting the stator carrier in the drive housing in a form-fitting manner. The connection element has a main body with a joining element for connection to the stator carrier in a form-fitting manner and with a latching hook for securing the stator in the drive housing. The drive housing has a joining contour which interacts with the latching hook of the connection element.

This nonprovisional application is a continuation of International Application No. PCT/EP2024/053203, which was filed on Feb. 8, 2024, and which claims priority to German Patent Application No. 10 2023 201 068.2, which was filed in Germany on Feb. 9, 2023, and which are both herein incorporated by reference.

### FIELD OF THE INVENTION

The present invention relates to a drive device, in particular an electromotive adjusting drive, for example, a seat adjusting drive, of a motor vehicle, comprising a brushless electric motor having an external-rotor design.

### DESCRIPTION OF THE BACKGROUND ART

A drive device, which drives an actuating element between two end position along an adjustment path, for example as an electromotive adjusting drive of a motor vehicle, usually comprises an electric motor having a stator and having a rotor, the stator being able to be received in a drive or electronics housing. If a gearing is coupled to the electric motor or to its rotor, it may be arranged in a separate housing part (gear housing) of the drive housing.

Drive devices which include a gearing arranged in the drive or gear housing, in particular having a 90° reversing gear (worm gear), are used or employed, for example, as window lifter drives in motor vehicles. The electric motor received in the drive or gear housing may be a brush-type (internal-rotor) commutator motor or also a brushless external-rotor motor. In a brushless, electrically or electronically commutated electric motor, the stator thereof has a rotary-field winding (stator winding) and a permanently excited rotor with or on a motor or rotor shaft, which is or may be coupled to the gearing.

A drive device for a window lifter of a motor vehicle is known from DE 102016 216 888 A1, which corresponds to US 2019/0277079, which is incorporated herein by reference, and in which a brushless electric motor of an external-rotor design (external-rotor motor) as well as a motor electronic system for the driving thereof are received in a drive or gear housing. The brushless (electrically or electronically commutated) electric motor includes a stator and a rotor designed as an external rotor having a rotor shaft (drive shaft), which supports a shaft-fixed worm of a worm gear as a 90° reversing gear. The worm gear is coupled to a cable drum, around which a pulling cable of a rail-guided entrainer for a window pane is wound with multiple cable windings or cable coils.

The stator has a stator main body with a number of stator teeth arranged in a star-shaped manner, which are wound with coils of a rotary-field winding. The stator main body is seated on a socket-shaped or hollow cylindrical stator carrier, which is connected to the gear housing and is penetrated by the rotor or drive shaft rotatably fixedly connected to the rotor. The gear housing at least partially receives the motor unit, the stator being connected to a stationary housing section of the gear housing via the socket-shaped stator carrier.

The stator carrier performs multiple functions in the drive device, in particular the connection and establishment of a connection of the stator to the drive or gear housing, the establishment of a fixed connection to the stator main body preferably designed as a stator laminated core, the supporting of the (rotor) shaft, in particular with the aid of a (radial or friction) bearing arranged in the socket-shaped or socket-like stator main body, and/or the ensuring of a good radial run out of the rotor to the stator.

### SUMMARY OF THE INVENTION

It is therefore an object of the invention to provide a particularly suitable drive device, in particular a suitable seat adjusting drive of a motor vehicle. A secure connection is to be provided between the (hollow cylindrical or socket-like) stator carrier or between the stator, including the stator carrier, and the drive housing. In particular, a suitable axial securing or a suitable securing of the stator (including the stator carrier) against rotation in the housing is to be given.

The drive device, which can be provided and configured, in particular, as an electromotive seat adjusting drive, comprises a brushless external-rotor electric motor and a drive housing as well as a connecting element, which is preferably provided separately.

The electric motor can include a stator having a rotary-field or stator winding formed, in particular, from individual coils and having a socket-shaped or hollow-cylindrical stator carrier. The electric motor includes, in particular, a rotor provided with permanent magnets which surround the stator, including a rotor shaft coupled thereto, which is guided through the hollow-cylindrical stator carrier. The stator has a stator main body, in particular in the form of a laminated core. The stator carrier is situated opposite the latter on at least one stator end face. The connecting element is used to fix the stator carrier or the stator in the drive housing in a form-fitting manner. A drive housing is understood here and in the following to be a gear or electronics housing, in particular also a partial housing of a drive housing.

The drive housing has an electronics compartment and a housing well, in which the stator, including the stator carrier or the premounted stator/rotor assembly of the electric motor, is received or insertable. The hollow-cylindrical stator carrier may be designed as a sintered component or preferably as a plastic component. A bearing or a bearing point for the rotor shaft may be mounted in this component used as a stator carrier.

The rotary-field or stator winding has a number of coils or (phase) connecting wires. These are preferably guided to corresponding contact or connecting points of a printed circuit board within an electronics compartment assigned to the drive housing to connect corresponding coils of the stator for the purpose of forming the rotary-field or stator winding, for example in a star or delta circuit.

The separate connecting element is suitably a plastic component or plastic clip. The connecting element includes a main body, which surrounds or encompasses the stator carrier at least partially or in regions, preferably at least nearly completely, and which includes at least one joining element for connection to the stator carrier in a form-fitting manner, and includes at least one joining element, in particular in the form of a latching hook, for securing the stator in the drive housing.

The drive housing includes a joining contour, which interacts with the latching hook of the connecting element. It is advantageously provided in the region of the electronic compartment or in the region between the latter and the housing well. The housing-side joining contour assigned to the particular latching hook, in particular a latching hook pair, of the connecting element is advantageously designed as an undercut for the latching hook.

When the stator is inserted into the drive or gear housing or into the housing well, including the assigned stator carrier and the connecting element positioned thereon, in particular in one premounting step, the or each stator-side or stator carrier-side latching hook of the connecting element engages behind the undercut on the housing side. The stator is secured thereby axially against an undesirable sliding out of the gear or drive housing.

The main body of the connecting element can have an annular shape. The at least one joining element can be formed onto the main body of the connecting element for securing the connecting element on the stator carrier, and the at least one latching hook is formed thereon to secure the stator or the stator carrier in the gear or drive housing.

The connecting element can have, in particular, a number of axial grooves corresponding to the number of (phase) connecting wires, for receiving the, in particular, radially bent-up connecting wires. The axial grooves can be arranged in a receiving grid, for example, in a comb-like molded part of the connecting element. The latter is suitably oriented tangentially—with respect to the annular main body of the connecting element or with respect to the circular circumference of the stator carrier—and is situated radially at a distance from the stator carrier.

The stator carrier can have a radially raised axial strut or an axially extending radial rib. The connecting element has a radial groove on its main body, which corresponds to the axial strut (radial rib) on the stator carrier side, for the purpose of securing the connecting element against rotation with respect to the stator carrier.

The connecting element can have a form-fitting element, and the gear housing can have a form-fitting contour which interacts with the form-fitting element, for example, in the region of the electronics compartment or in the region between the latter and the housing well. The form-fitting element of the connecting element can be, in particular, a joining pin or a joining rib which projects axially over the main body, and the form-fitting contour on the housing side is advantageously a corresponding joining groove.

The connecting element can be, for example, a latching hook pair with latching hooks offset by 180° on the main body. The latching hooks arranged opposite each other on the circumference of the main body are suitably an integral part of spring-elastic latching arms, which extend axially—with respect to the rotation axis of the electric motor or its rotor or rotor shaft—and may engage or disengage radially. Three, four, five, or more latching hooks may also be provided in a 120° angle distribution, or in a 90° angle distribution, or in a 72° angle distribution.

When the stator, including the assigned stator carrier, is inserted into the gearing or drive housing or into the housing well, and the connecting element is positioned thereon, in particular in one premounting step, the latching hooks move along a housing or joining contour via pivoting in order to subsequently engage behind them after a spring-back of the latching arms. In other words, the housing-side joining contour assigned to the particular latching hook of the connecting element is suitably designed or effective as a recess, behind which the particular latching hook engages when the stator is inserted into the gear housing or into its housing well.

The main body of the connecting element further advantageously has a joining element pair with latching elements offset by 180°. The latching elements arranged opposite each other on the circumference of the main body are suitably an integral part of spring-elastic latching arms, which extend axially—with respect to the rotation axis of the electric motor or its rotor or rotor shaft—and may engage or disengage radially. Once again, three, four, five, or more joining or latching elements may also be provided.

These joining or latching elements are advantageously provided at the approximate or exact position of the latching hooks or the corresponding latching hook pair of the main body of the connecting element, while preferably extending in the opposite (axial) direction. The background here is or essentially is that the flow of force through the connecting element takes place over the shortest possible paths, the connecting element is deformed as little as possible as a component during operation and during mounting, and the smallest possible component stresses occur.

The preferably annular connecting element is secured on the stator carrier in a form-fitting manner, in particular against axial displacement on the stator carrier, with the aid of these joining or latching elements. For this purpose, the stator carrier suitably has an, in particular, bead-like latching opening or latching recess corresponding to the particular joining or latching element, with which the joining or latching element engages or latches when the connecting element is positioned on the stator carrier.

According to an example of the connecting element, its annular main body can have a joining slit with the joining element or joining element pair arranged thereon, which engage behind the or a radially raised axial strut or the or an axially extending radial rib of the stator carrier when the connecting element is positioned thereon. Due to the joining slit, the main body of the connecting element forms two approximately semicircular or semi-annular spring arms, which may be displaced radially and swing in upon the constriction of the joining slit.

The engagement of the joining elements of the connecting element behind the radially raised axial strut of the stator carrier may be locked with the aid of a housing-side locking contour when the stator is inserted into the gear housing or its housing well. The joining slit of the annular main body advantageously takes on a dual function, in that it also form the radial groove corresponding to the or an axial strut (radial rib) on the stator carrier side for securing the connecting element against rotation with respect to the stator carrier.

A stator insulation can be assigned to the stator, which surrounds a stator main body designed, for example, as a stator laminated core at least partially or in regions. The stator carrier may also be a plastic component or a plastic injection-molded part. The stator insulation or the stator carrier suitably has a radially raised contour with insertion grooves for the advantageously radially bent-up (phase) connecting wires.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows a perspective representation of a drive device designed as a seat adjusting drive of a motor vehicle, comprising a drive housing for receiving an electric motor designed as an external-rotor motor;

FIG. 2 shows a sectional representation of the drive device along line II-II in FIG. 1;

FIG. 3 shows a perspective representation of a stator of the electric motor, including a rotary-field or stator winding and having a stator main body as well as having a hollow-cylindrical stator carrier;

FIGS. 4 and 5 show different views of a first variant of a connecting element having an annular main body and latching hooks and joining elements formed thereon;

FIG. 6 shows a perspective representation of the stator according to FIG. 3, with the connecting element according to FIGS. 4 and 5 positioned on the stator carrier;

FIG. 7 shows a perspective representation of the stator according to FIG. 6 in a mounting position prior to insertion into the sectionally illustrated drive housing, with a view into an electronics compartment;

FIG. 8 shows a top view of the stator inserted into the sectionally illustrated drive housing;

FIG. 9 shows a sectional representation according to FIG. 2 of the stator secured in the sectionally illustrated drive housing with the aid of the connecting element;

FIGS. 10 and 11 show different views of a second variant of the connecting element having an annular main body, joining elements, and latching hooks;

FIG. 12 shows a perspective representation of the stator, with the connecting element of the example according to FIGS. 10 and 11 positioned on the stator carrier;

FIG. 13 sectionally shows the stator, with the connecting element of the second variant positioned on the stator carrier, with a view of a radially raised axial strut of the stator carrier and with a joining element interacting therewith at a joining slit of the connecting element;

FIG. 14 sectionally shows a (partially cutaway) perspective representation of the stator according to FIG. 13 inserted into the drive housing, including a joining element of the connecting element locked with the aid of a locking contour on the housing side; and

FIG. 15 shows a perspective representation of a drive device provided and configured as a window lifter drive, comprising a drive housing and an electric motor designed as an external-rotor motor received therein.

### DETAILED DESCRIPTION

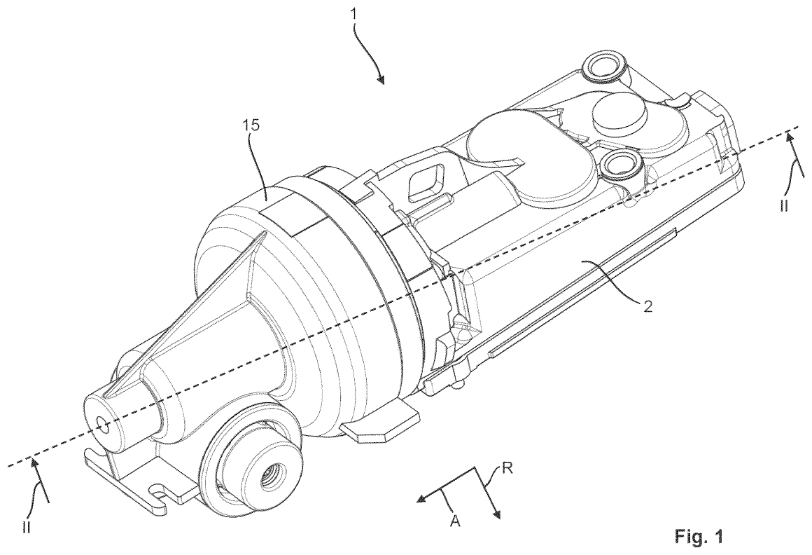

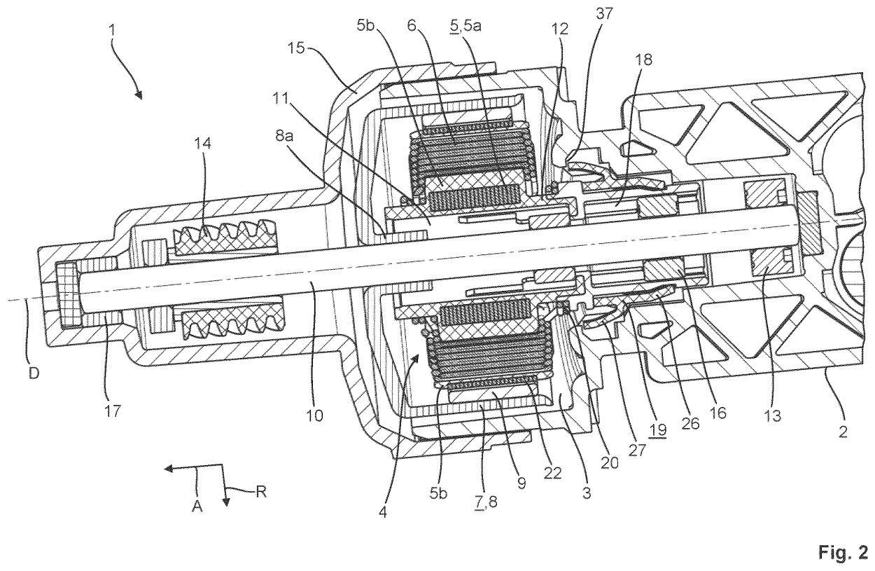

FIGS. 1 and 2 show an electromotive drive device 1, preferably provided as a seat adjusting drive of a motor vehicle, in a perspective representation and sectionally in a longitudinal cut along lines II-Il in FIG. 1, respectively. Drive device 1 comprises a drive housing 2, also referred to below as a housing, which has a housing well 3, via which an electric motor 4 designed as an external-rotor motor is guided into housing 2.

Electric motor 4 includes a stator 5 having a stator or rotary-field winding 6 as well as a rotor 7 surrounding the latter, which includes an, in particular, pot-like or hood-shaped rotor housing 8 and permanent magnets 9 arranged on its cylindrical inner wall. Rotor housing 8—and thus rotor 7—is connected to a motor shaft 10 in a rotatably fixed or shaft-fixed manner. For this purpose, rotor housing 8 has a shaft passage 8a pressed with motor shaft 10 and protruding into housing well 3. Stator 5 has a stator main body 5a, preferably designed as a laminated core made up of stacked stator laminations, which is at covered or surrounded by a stator insulation 5b at least partially or in regions.

Motor shaft 10 is guided via a shaft feed-through 11 of a stator assembly 12 into (drive) housing 2, where it is supported in a rotatably movable manner in a housing-side bearing 13, in particular a radial and/or friction bearing. A shaft section of motor shaft 10, on which a worm 14 is arranged in a rotatably fixed or shaft-fixed manner, is guided into a housing part 15. The latter encompasses housing well 3 of housing 2 of drive device 1 configured as a seat adjusting drive in a collar-like manner.

Motor shaft 10 is rotatably supported in stator assembly 12, which is provided here with at least one bearing point 16, in particular a bearing preferably designed as a radial and/or friction bearing. A further bearing 17 is provided in housing part 15. Worm 14 meshes with a gear wheel in a manner which is not illustrated in greater detail, for example forming a) (90° reversing gear.

Stator assembly 12, which forms stator 5 together with stator or rotary-field winding 6, includes a stator carrier 18, on which a connecting element 19 is arranged. Stator or rotary-field winding 6 preferably has connecting wires 20, which are preferably used as phase connections.

In the figures, axial direction A and radial direction R are clarified by arrows, and rotation or motor axis of motor shaft (rotor or drive shaft) 10 of electric motor 4, illustrated by the dash-dot line, is designated by D.

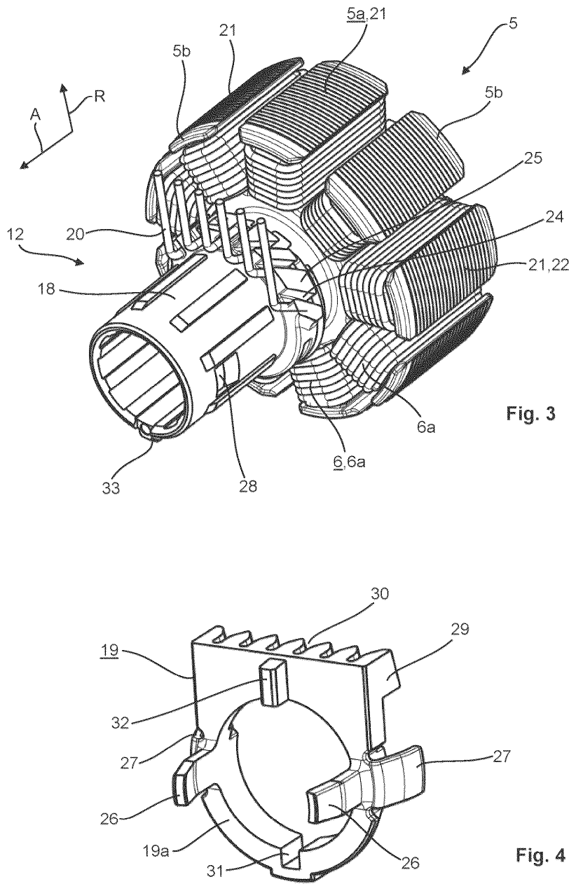

FIG. 3 shows stator 5, including stator assembly 12 carrying stator or rotary-field winding 6, whose stator main body 5a has stator teeth 21 arranged in a star shape. The latter are provided with stator insulation 5b, forming end-face open spaces (pole shoes) 22, for example in the form of cap-like coil coverings or a plastic casing, at least in regions. Stator insulation 5b, which at least partially covers stator teeth 21 oriented radially to the outside in a star-shaped manner, is wound together with stator teeth 21 by coils 6a forming stator or rotary-field winding 6. Their coil ends are partially connected to each other, some of the coil ends being run out as (phase) connecting wires 20.

Stator assembly 12 or stator 5 has hollow-cylindrical or socket-like stator carrier 18. In the example, stator carrier 18, which protrudes axially over stator main body 5a, is a plastic component formed onto stator insulation 5b, but it may also be designed as a sintered component and be inserted or pressed into stator main body 5a. Motor or rotor shaft 10 of electric motor 4 becomes or is guided into housing 2 via hollow-cylindrical stator carrier 18.

In the example, the six run-out connecting wires 20 provided as phase connections of stator or rotary-field winding 6 are guided in insertion grooves 24 of a contour 25 raised (radially) in radial direction R. Connecting wires 20 are bent up radially outside insertion grooves 24 on the side of contour 25 facing away from stator main body 5a. Contour 25, including insertion grooves 24, is suitably formed onto stator carrier 18. In the case of a cap-like coil covering (groove box insulation) as coil insulation 5b, in particular, contour 25, including insertion grooves 24, may also be formed thereon.

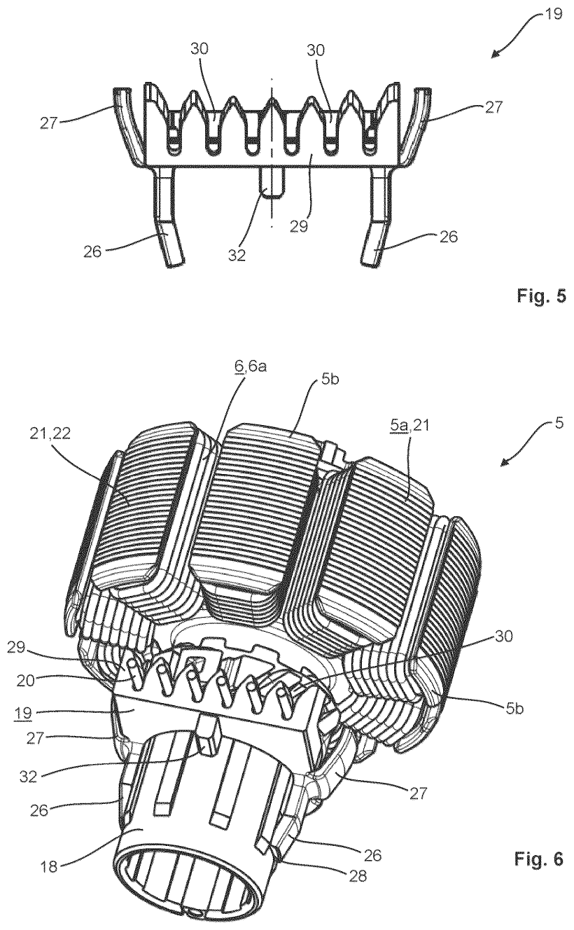

FIGS. 4 and 5 show a first variant of connecting element 19 in two different views. It is provided and configured to securely connect stator 5 or stator assembly 12, including stator carrier 18 and stator or rotary-field winding 6, to stator carrier 18, on the one hand, and to housing 2, on the other hand, or to hold it therein, with the aid of a form-fitting connection.

A “form fit” or a “form-fitting connection” between at least two parts connected to each other is understood here and in the following to mean, in particular, that the interconnected parts are held together, at least in one direction, by a direct engagement of contours of the parts themselves or by an indirect engagement via an additional connecting part. The “blocking” of a movement with respect to each other in this direction thus takes place depending on the shape.

The securing effectuated with the aid of connecting element 19 between stator carrier 18 and gear housing 2 is preferably an axial securing of stator 5 or stator assembly 12 against sliding out of housing 2 in axial direction A. However, this securing is, in particular, a securing against rotation of stator 5 or stator assembly 12 within housing 2 or of connecting element 19 with respect to stator carrier 18, on which connecting element 19 is seated in the mounted state. This (first) variant of connecting element 19 is particularly suitable, in particular, for a stator carrier 18 manufactured from plastic.

Connecting element 19 is preferably a plastic component or a plastic clip. Connecting element 19 has an annular main body 19a, via which connecting element 19 practically completely encompasses or surrounds stator carrier 18. Connecting element 19 also has a joining element 26, designed here as a latching element pair, for the form-fitting connection to stator carrier 18 and a latching hook 27, designed here as a latching hook pair, for securing stator 5 or stator carrier 18 in gear housing 2.

Latching hooks 27 are arranged so as to be offset by 180° on main body 19a of connecting element 19. Latching hooks 27 arranged opposite each other on the circumference of main body 19a are an integral part of spring-elastic latching arms, which extend axially-with respect to rotation axis D of electric motor 4—and may engage or disengage radially.

Joining or latching elements 26 designed as a latching element pair and arranged opposite each other in a manner offset by 180° on the circumference of main body 19a are an integral part of spring-elastic latching arms, which extend axially and may be engaged or disengaged radially. These joining or latching elements 26 are arranged at the position of latching hooks 27 or corresponding latching hook pair of main body 19a of connecting element 19 and extend in opposite axial direction A. Annular connecting element 19 is secured on stator carrier 18 in a form-fitting manner and against axial displacement on stator carrier 18, with the aid of these joining or latching elements 26. For this purpose, stator carrier 18 has corresponding latching openings or latching recesses 28 (FIG. 3), into which particular joining or latching element 26 engages or latches when connecting element 19 is positioned on stator carrier 18.

Connecting element 19 has a comb-like molded part 29 with a number of axial grooves 30 for receiving radially bent-up connecting wires 20 of stator or rotary-field windings 6. Axial grooves 30 are arranged in a receiving grid. The latter is oriented tangentially—with respect to annular main body 19a of connecting element 19 or with respect to the circular circumference of stator carrier 18—and is situated radially at a distance from stator carrier 18. Connecting element 19 also has a radial groove 31 on its main body 19a. Connecting element 19 furthermore has a form-fitting element 32 in the form of a joining pin or joining rib, which protrudes axially over main body 19a (in axial direction A).

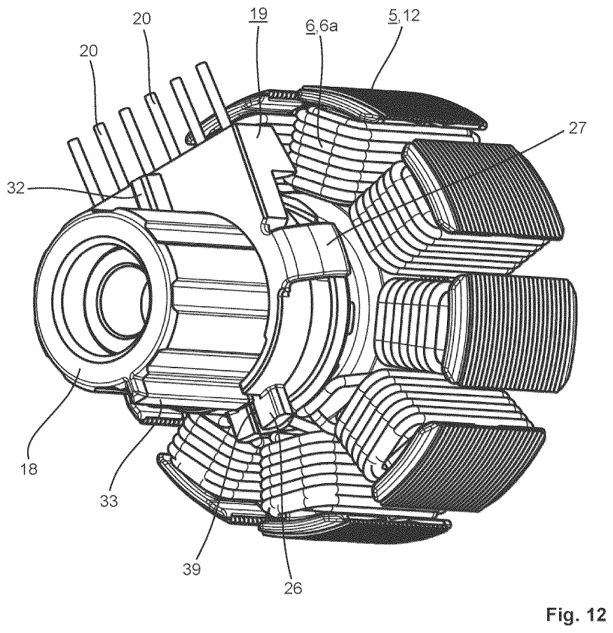

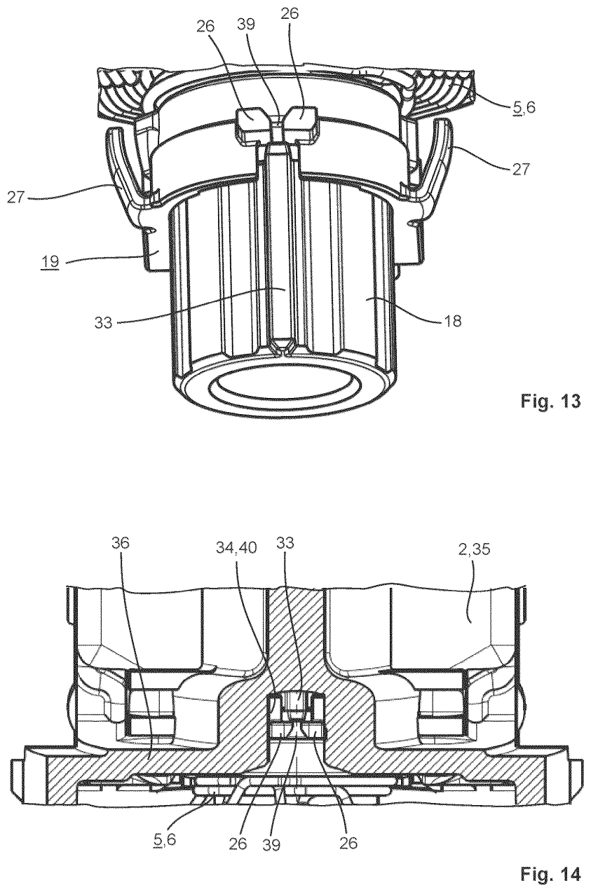

As is apparent, in particular, in FIG. 3 as well as FIGS. 12 and 13, stator carrier 18 has a radially raised axial strut 33 or an axially extending radial rib. When connecting element 19 is positioned or pushed onto stator carrier 18, carrier-side axial strut (radial rib) 33 engages with radial groove 31 of connecting element 19. Connecting element 19 is arranged thereby on stator carrier 18 or thereon in the predetermined location or defined position so that it is secured against rotation.

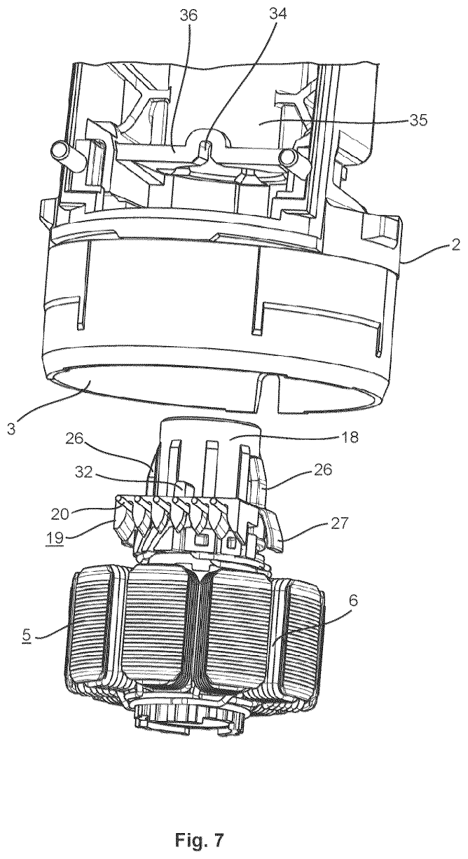

FIGS. 6 and 7 show stator 5 or stator assembly 12 with connecting element 19 already positioned on stator carrier 18 in a premounting step. This assembly 12, which includes stator main body 5a carrying stator insulation 5b and stator carrier 18 as well as stator 5 having stator or rotary-field winding 6, and with connecting element 19 positioned thereon, has the considerable advantage that (phase) connecting wires 20 of stator or rotary-field winding 6 with connecting element 19 mounted on stator carrier 18, with the aid of which comb-like molded part 29 having axial grooves 30 is already oriented in the target position in this mounting step or state and is or becomes fixed in this position.

During the positioning of connecting element 19 on stator carrier 18, spring-elastic joining or latching elements 26 are first displaced radially to the outside to engage with the carrier-side latching openings or latching recesses 28 in or at the position thereof. When connecting element 19 is positioned on stator carrier 18, radially bent-up connecting wires 20 of stator or rotary-field winding 6 engage with axial grooves 30 of connecting element 19. Insertion grooves 24 or contour 25 of stator carrier 18 having these grooves may be first deformed, in particular to fix connecting wires 20 in the desired position.

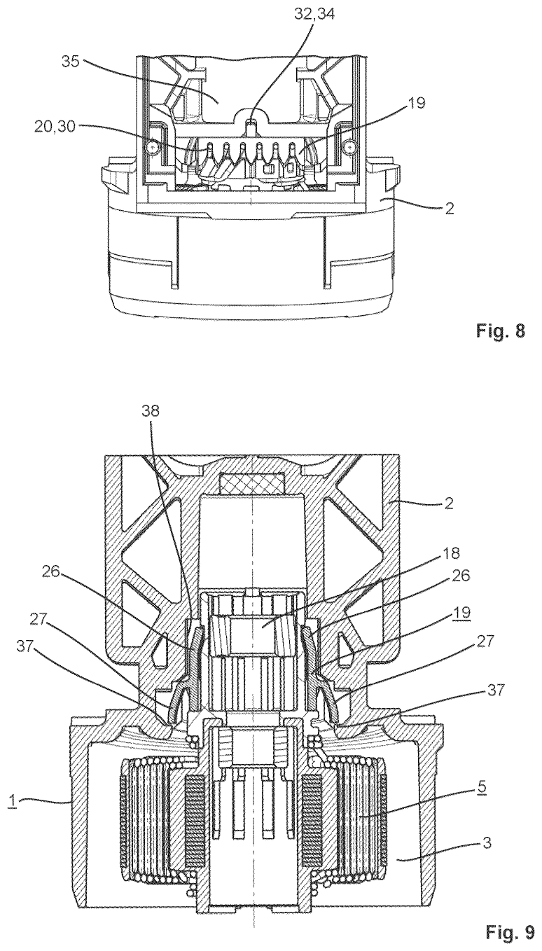

As is apparent from FIGS. 7 and 8, housing 2 has a form-fitting contour 34, which interacts with form-fitting element 32 of connecting element 19. It is advantageously arranged in a partition or intermediate wall 36 of housing 2 in the region between an electronics compartment 35 and housing well 3 of housing 2. Stator 5, together with stator assembly 12 and together with stator or rotary-field winding 6, as well as with mounted connecting element 19, is inserted into housing 2 via housing well 3.

As is apparent from FIG. 9, latching hooks 27 of connecting element 19 seated on stator carrier 18 engage with a housing or joining contour 37 of housing 2 acting as an undercut when stator 5 is inserted into housing 2. For this purpose, latching hooks 27 engage behind housing-side joining contour 37 in the intended position or location of stator 5 in housing 2. In this location of stator 5 in gear housing 2, a further, in particular, well-like housing contour 38 of housing 2 effectuates a locking of the form-fitting connection of stator carrier 18 to connecting element 19 in that housing contour 37 prevents a radial displacement of joining or latching elements 26. Stator 5 is securely fixed in housing 2 thereby or is reliably secured against an axial sliding out from housing 2. Axial grooves 30 of connecting element 19 reliably receive radially bent-up connecting wires 20 of stator or rotary-field winding 6, in particular in a precisely positioned and oriented manner. Connecting wires 20 are supported in their intended orientation and reliably positioned, in particular to be contacted in a failsafe manner at corresponding connecting points of a printed circuit board, which is received in electronics compartment 35.

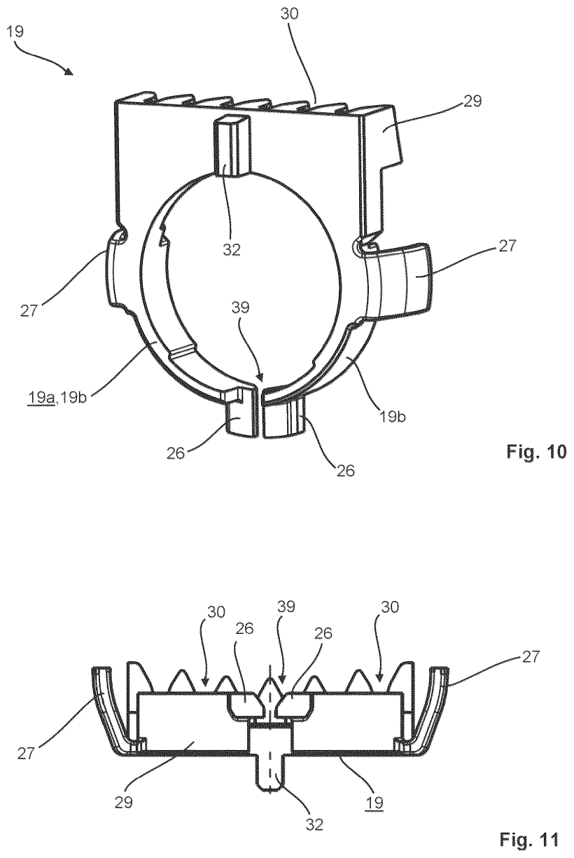

FIGS. 10 and 11 show different views of a second variant of connecting element 19, which in this second variant is suitable, in particular, for a sintered stator carrier 18. This connecting element 19 is also provided and configured to securely connect stator 5 or stator assembly 12, including stator carrier 18 and stator or rotary-field winding 6, to stator carrier 18, on the one hand, and to housing 2, on the other hand, or to hold it securely therein, with the aid of a form-fitting connections. The second variant of connecting element 19 differs from the first variant by the type of joining element 26 for the form-fitting connection or holding of connecting element 19 to or on stator carrier 18.

According to the second variant of connecting element 19, the annular main body 19a thereof has a joining slit 39 with radial pins or nubs arranged thereon as joining element 26 or the joining element pair. The latter or joining slit 39 is provided on the side of annular main body 19a opposite pin-or rib-like form-fitting element 32—i.e., offset by 180°. Due to joining slit 39, main body 19a of connecting element 19 is divided, forming approximately semi-annular or semicircular latching or spring arms 19b. These may be displaced radially to the outside and be guided against each other or pressed together, reducing the slit width or opening of joining slit 39.

More or less similarly to radial groove 31 of the first variant, joining slit 39 forms the mating contour for the axial strut or radial rib 33 of stator carrier 18, in particular with the radial pins flanking it as joining elements 26, to secure connecting element 19 against rotation. The radial pins additionally take on the function of axially securing stator 5 in housing 2 as joining elements 26 in interaction with spring arms 19b of main body 19a of connecting element 19.

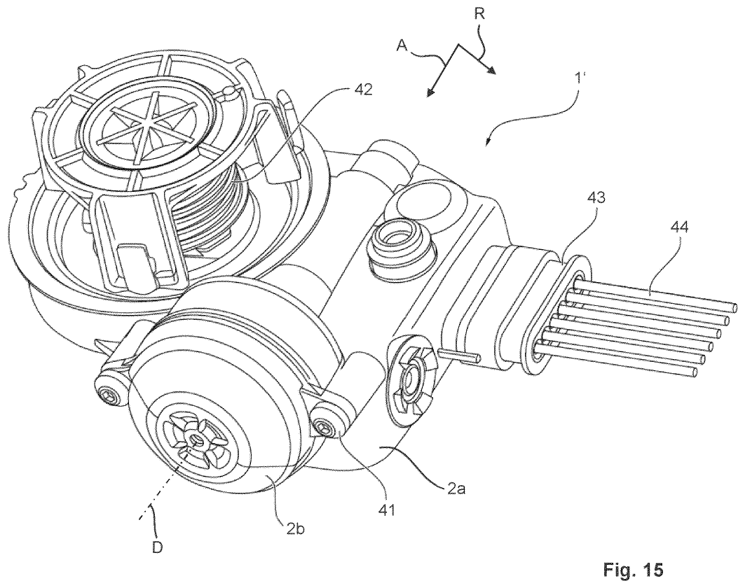

FIG. 14 shows stator 5 inserted into housing 2 via housing well 3 with the second variant of connecting element 19 on stator carrier 18. It is apparent that joining elements 26 of connecting element 19, which flank joining slit 39, as well as axial strut 33 of stator carrier 18 are seated in wall-side form-fitting contour 34 of housing 2.

Housing-side form-fitting contour 34 forms a locking contour 40 with or on the side edges. It effectuates a pressing together of joining elements 26 when joining elements 26 of connecting element 19 penetrate corresponding form-fitting contour 34 on the housing side, thus decreasing (reducing) the slit width of joining slit 39. Joining elements 26 engage behind radially raised axial strut 33 of stator carrier 18. This undercut or recess is locked with the aid of housing-side locking contour 40 when stator 5 is inserted into housing 2 or into its housing well 3. Joining slit 39 of annular main body 19a of connecting element 19 takes on a dual function, in that it also forms radial groove 31 corresponding to axial strut (radial rib) 33 on the stator carrier side for securing connecting element 19 against rotation with respect to stator carrier 18.

FIG. 15 shows an electric drive device 1′, which is particularly suitable as a window lifter drive, comprising a (drive) housing 2 formed, in particular, from a gear housing part 2a and a motor housing part 2b. Electric motor 4 designed as an external-rotor motor is inserted thereinto, to which stator assembly 12 having stator or rotary-field winding 6 is rotatably fixedly and axially secured with the aid of connecting element 19. Gear housing part 2a and motor housing part 2b are detachably connected to drive housing 2 with the aid of a flange connection, preferably screwed via flange screws 41. A non-detachable connection, e.g. a weld joint, may also be provided. In the example, external-rotor motor 4 drives a cable drum 42 of a window lifter via a gearing as the output element.

The gearing here is a 90° reversing gear, in particular a worm gear. The worm wheel thereof (not visible) arranged in gear housing part 2a, which is coupled to cable drum 42 of the window lifter of a motor vehicle, around which a pulling cable is wound, meshes with a worm (not visible here) driven by external-rotor electric motor 4. It is seated on the drive or rotor shaft of the electric motor, whose rotor is rotatably fixedly connected to the rotor shaft. A connecting plug 43 having connecting cables 44 for supplying current and voltage to drive device 1′ as well as for supplying and/or discharging control and/or sensor signals is plugged into a connecting receptacle on the housing side.

In summary, the invention relates to a drive device 1, comprising a brushless electric motor 4 with a stator 5, which has a rotary-field or stator winding 6 and a hollow-cylindrical stator carrier 18, and comprising a drive housing 2 as well as a connecting element 19 for fixing stator carrier 18 in housing 2 in a form-fitting manner, connecting element 19 having a preferably annular main body 19a with a joining element or latching element pair 26 for connection to stator carrier 18 in a form-fitting manner and with a latching hook or latching hook pair 27 for securing stator 5 in housing 2, and housing 2 having a joining contour 37, which interacts with a latching hook 27 of connecting element 19 and is designed, in particular, as an undercut.

The claimed invention is not limited to the examples described above. Instead, other variants of the invention may be derived therefrom by those skilled in the art within the scope of the disclosed claims without departing from the subject matter of the claimed invention. Moreover, in particular, all individual features described in connection with the various examples within the scope of the disclosed claims may also be otherwise combined without departing from the subject matter of the invention.

The described approach may be used not only in the specifically described application case but also, in a similar design, in other motor vehicle applications, for example in door and hatch systems, in vehicle locks, in interior systems, as well as in further electrical drives in the vehicle.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A drive device comprising:
a brushless electric motor with a stator, which has a rotary-field or stator winding with at least two connecting wires and a socket-shaped or hollow-cylindrical stator carrier;
a drive housing with a housing well, in which the stator or the electric motor or a stator/rotor assembly is received or insertable; and
a separate connecting element to fix the stator carrier in the drive housing in a form-fitting manner or exclusively,
wherein the connecting element has a main body which encompasses the stator carrier at least partially or in regions and includes at least one joining element for connection to the stator carrier in a form-fitting manner, and includes at least one latching hook to secure the stator in the drive housing, and
wherein the drive housing has a housing or joining contour, which interacts with the at least one latching hook of the connecting element in a region of an electronics compartment or in a region between the electronics compartment and the housing well.

2. The drive device according to claim 1, further comprising an annular main body, on which at least one latching hook and the at least one joining element are formed.

3. The drive device according to claim 1, wherein the connecting element has at least two axial grooves, which correspond to the connecting wires and are arranged, in a tangentially oriented receiving grid situated radially at a distance from the stator carrier for receiving the radially bent-up connecting wires.

4. The drive device according to claim 1, wherein the stator carrier has a radially raised axial strut, and the connecting element has, on its main body, a radial groove corresponding to the axial strut on the stator carrier side for securing the connecting element against rotation with respect to the stator carrier.

5. The drive device according to claim 1, wherein the connecting element has a form-fitting element, and the housing has a form-fitting contour, which interacts with the form-fitting element of the connecting element in a region of an electronics compartment or in a region between the electronics compartment and the housing well.

6. The drive device according to claim 1, wherein the connecting element has a latching hook pair with latching hooks offset by 180° on the main body, or the connecting element has at least two latching hooks arranged or provided on the main body at different or equidistant angle positions.

7. The drive device according to claim 1, wherein the housing-side joining contour, assigned to the particular latching hook of the connecting element, is designed as an undercut, behind which the particular latching hook engages when the stator is inserted into the drive housing or into its housing well.

8. The drive device according to claim 1, wherein the main body of the connecting element has a latching element pair with joining or latching elements offset by 180°, or wherein the main body of the connecting element has at least two joining or latching elements, which are arranged or provided at different, preferably equidistant, angle positions, and/or wherein the annular main body of the connecting element has a joining slit with a joining element arranged thereon or a joining element pair, which engages behind the or a radially raised axial strut of the stator carrier when the connecting element is positioned thereon, the rear grip being locked with the aid of a locking contour on the housing side when the stator is inserted into the drive housing or into its housing well.

9. The drive device according to claim 8, wherein the stator carrier has a latching opening corresponding to the joining or latching element, into which the joining or latching element engages or latches when the connecting element is positioned on the stator carrier.

10. The drive device according to claim 1, wherein the stator carrier has a contour with insertion grooves for the connecting wires, the connecting wires being bent up radially.

11. The drive device according to claim 1, wherein the drive device is an electromotive seat adjusting drive of a motor vehicle.
